(19) United States
(12) Patent Application Publication
(10) Pub. No.: US 2021/0285597 A1
(43) Pub. Date: Sep. 16, 2021

(54) MOUNTING STRAP

(71) Applicant: Paul Reichard, Gig Harbor, WA (US)

(72) Inventor: Paul Reichard, Gig Harbor, WA (US)

(21) Appl. No.: 16/816,095

(22) Filed: Mar. 11, 2020

(51) Int. Cl. F16M 13/02; B62B 5/00; A45F 5/00

(52) U.S. Cl. CPC F16M 13/022; A45F 2005/006; A45F 5/00; B62B 5/00

(57) ABSTRACT

A mounting system includes a strap having a first and second portions. A first side of the first portion has gripping material applied thereto and a second side of the first portion includes first fastening material. A first side of the second portion includes second fastening material such that when the first portion is wrapped around a structure, the second portion may be wrapped around the first portion with the second fastening material engaging the first fastening material. Mounting systems may secure a shelf assembly to vertical supports of a dolly. The shelf assembly has a back wall and foldable sidewalls with cross straps, the sidewalls including straps attachable to the mounting systems on the vertical supports. A foldable shelf rests on the cross straps. Straps on sides of the shelf attach to the sidewalls to unfold the shelf. A rear side of the shelf secures to

### FIELD OF THE INVENTION

This invention relates to straps for suspending or securing items.

### BACKGROUND OF THE INVENTION

The need often arises to mount or secure something to a frame. Frames are often made of round or square metal tubes. These tubes are often polished smooth and painted or powder coated, which means straps and ropes will tend to slide. Fixed mounting is therefore difficult unless a structure is welded or clamped to the frame to provide an attachment point.

It would be an advancement in the art to provide means for mounting items at arbitrary locations on a smooth frame.

### SUMMARY OF THE INVENTION

In one aspect of the invention, a mounting system includes a strap having a first end and a second end. A first portion of the strap includes the first end and a second portion includes the second end. A gripping material is secured to a first side of the first portion. A first pressure-engaged releasable fastening element secured to a second side of the first portion. A second pressure-engaged releasable fastening element is secured to a first side of the second portion. An attachment structure is secured to the first end and configured to fasten to an item secured thereto.

In some embodiments, the first pressure-engaged releasable fastening element is loop material for a hook-and-loop fastening system and the second pressure-engaged releasable fastening element is hook material for the hook-and-loop fastening system.

In some embodiments, the first pressure-engaged releasable fastening element and the second pressure-engaged releasable fastening element are 3M DUAL LOCK™ material.

In some embodiments, the mounting system includes a tab secured to the first portion and protruding outwardly therefrom. A first side of the tab faces a same direction as a first side of the strap, the first side of the tab having a third pressure-engaged releasable fastening element secured thereto. The third pressure-engaged releasable fastening element may be of a same type as the second pressure-engaged releasable fastening element. In some embodiments, a second side of the tab is opposite the first side and has a fourth pressure-engaged releasable fastening element, the fourth pressure-engaged releasable fastening element being of a different type from the third pressure-engaged releasable fastening element and a same type as the second pressure-engaged releasable fastening element.

In some embodiments, the gripping material is a coating of a gripping polymer. In other embodiments, the gripping material is a polymer foam adhered to the strap.

In some embodiments, the attachment structure is a loop. The attachment structure may be a ring secured to the strap. The attachment structure may be a portion of a buckle. The attachment structure may be a portion of a side-release buckle.

A method of use may include wrapping the first portion around a mounting structure having the gripping material facing and contacting the mounting structure. The second portion is wrapped around the first portion such that the second pressure-engaged releasable fastening element engages the first pressure-engaged releasable fastening element.

Wrapping the first portion around the mounting structure may include wrapping the first portion at a wrapping angle relative to the mounting structure. Wrapping the second portion around the first portion may include wrapping the second portion at an overwrapping angle oriented in an opposite direction from the wrapping angle. The wrapping angle may be between 20 and 70 degrees. The wrapping angle may be between 30 and 60 degrees.

The mounting system may be a first mounting system. A second mounting system may be secured to the attachment structure. The second mounting system may also be secured to the mounting structure.

In some embodiments, the mounting system includes a tab secured to the first portion and projecting outwardly therefrom, a third pressure-engaged fastening element being secured to a first side of the first portion facing a same direction as the first side of the first portion. In use, the first portion is wrapped around the mounting structure and the first pressure-engaged fastening element is engaged with the third pressure-engaged fastening element effective to hold the mounting system in place on the mounting structure during wrapping of a remainder of the first portion around the mounting structure.

The first pressure-engaged fastening element and the second pressure-engaged fastening element are materials according to at least one of a hook-and-loop fastening system and 3M DUAL LOCK fastening system.

### BRIEF DESCRIPTION OF THE DRAWINGS

Preferred and alternative examples of the present invention are described in detail below with reference to the following drawings:

FIG. 1 is a front view of a mounting system in accordance with an embodiment of the present invention;

FIG. 2A is a side view of the mounting system of FIG. 1;

FIG. 2B is a side view of an alternative embodiment of the mounting system of FIG. 1;

FIG. 3 is a rear view of the mounting system of FIG. 1;

FIG. 4 illustrates initiation of wrapping of the mounting system around a structure in accordance with an embodiment of the present invention;

FIG. 5 illustrates wrapping of a first portion of the mounting system around the structure in accordance with an embodiment of the present invention;

FIG. 6 illustrates over-wrapping of a second portion of the mounting system over the first portion of the mounting system in accordance with an embodiment of the present invention;

FIG. 7 illustrates the mounting system secured to the structure and ready for use in accordance with an embodiment of the present invention;

FIG. 8 is a front view of an alternative embodiment in which an attachment structure is secured to two mounting systems in accordance with an embodiment of the present invention;

FIG. 9 is a rear view of the embodiment of FIG. 8;

FIG. 10 illustrates initiation of wrapping of first portions of the two mounting systems around a structure in accordance with an embodiment of the present invention;

FIG. 11 illustrates over-wrapping of the second portions of the two mounting systems over the first portions in accordance with an embodiment of the present invention;

FIG. 12 illustrates the two mounting systems secured to the structure and ready for use in accordance with an embodiment of the present invention;

FIG. 13 is a front view of an alternative implementation of a two-mounting system embodiment in accordance with an embodiment of the present invention;

FIG. 14 illustrates initiation of wrapping of first portions of the two mounting systems of FIG. 13 around a structure in accordance with an embodiment of the present invention;

FIG. 15 illustrates over-wrapping of the second portions of the two mounting systems of FIG. 13 over the first portions in accordance with an embodiment of the present invention;

FIGS. 16A to 16D illustrate a mounting system incorporating conductors for implementing an electromagnet in accordance with an embodiment of the present invention;

FIG. 17 illustrates the wrapping of the mounting system incorporating conductors of FIGS. 16A and 16B around a structure in accordance with an embodiment of the present invention;

FIG. 18 illustrates the wrapping of the mounting system incorporating conductors of FIGS. 16C and 16D around a structure in accordance with an embodiment of the present invention;

FIG. 19 is a rear isometric view of a dolly having a detachable shelf assembly mounted thereto in accordance with an embodiment of the present invention;

FIG. 20 is a front isometric view of the dolly and detachable shelf assembly in accordance with an embodiment of the present invention;

FIGS. 21 and 22 are isometric views of a shelf for use in the detachable shelf assembly in accordance with an embodiment of the present invention;

FIG. 23 is a rear isometric view of a shelf housing of the detachable shelf assembly in accordance with an embodiment of the present invention;

FIG. 24 is a front isometric view of the shelf housing of the detachable shelf assembly in accordance with an embodiment of the present invention;

FIG. 25 is an isometric view of a shelf in a folded configuration in accordance with an embodiment of the present invention;

FIG. 26 is an isometric view of the shelf housing in a folded configuration in accordance with an embodiment of the present invention;

FIG. 27 is a cross-sectional view illustrating an example configuration for the walls of the shelf housing in accordance with an embodiment of the present invention;

FIG. 28 is an isometric view of an expandable shelf housing in accordance with an embodiment of the present invention; and

FIG. 29 is an isometric view of the expandable shelf housing of FIG. 26 with its right and left sides separated from one another.

### DETAILED DESCRIPTION OF THE PREFERRED EMBODIMENTS

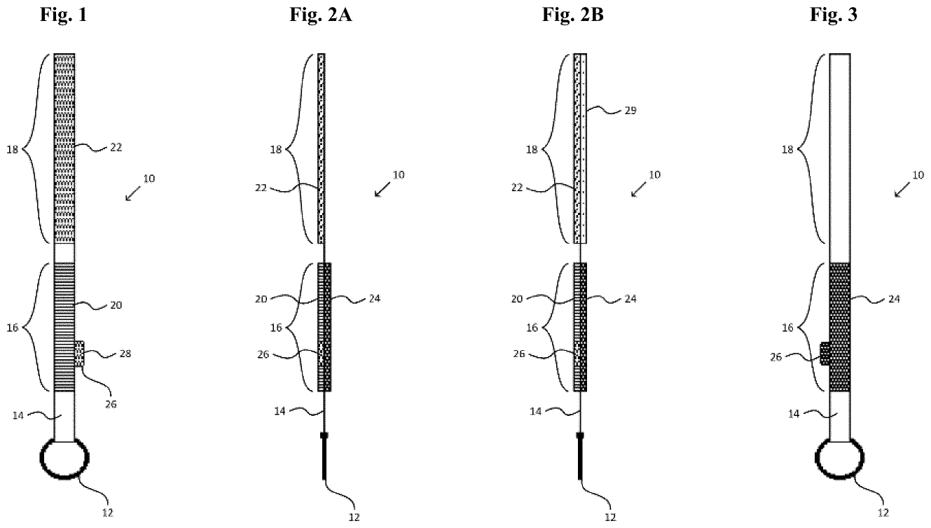

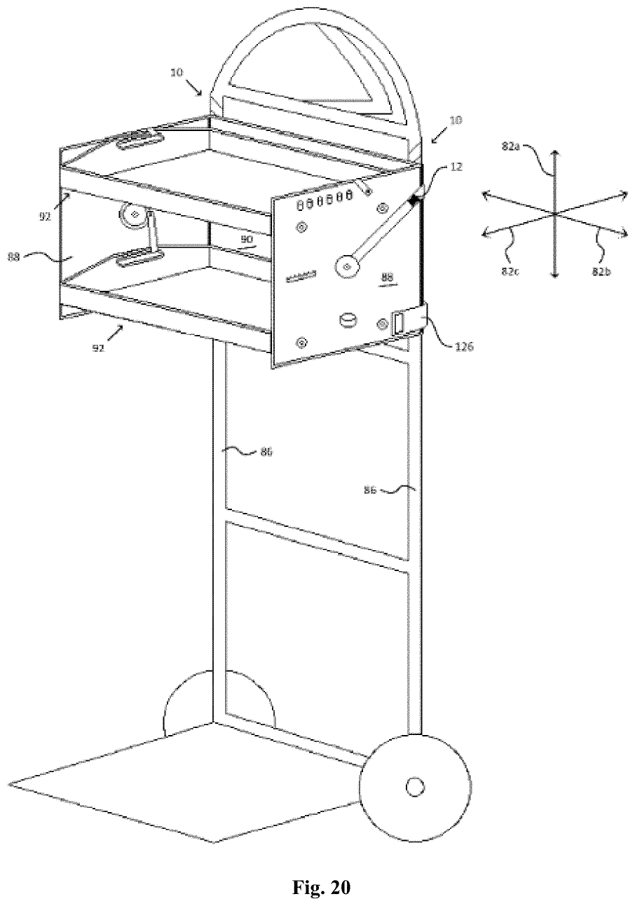

FIGS. 1, 2A, and 3 illustrate a mounting system 10 that may be mounted to a bar, rod, or other structure of round, square, oval, or other cross sectional shape and provide an attachment structure 12 to which straps or other items may secure. The attachment structure 12 is a ring, such as a metal (steel, aluminum, etc.), in the illustrated embodiment. The attachment structure 12 may be part of a buckle, such as one part of a side release buckle, or any other attachment structure known in the art. As described below, the mounting system 10 can secure to a structure and maintain its position while loaded, thereby providing an arbitrarily positioned and stable mounting point for various purposes. The mounting system 10 is particularly suitable for use with the detachable shelf assembly described below with respect to FIGS. 20 through 26, though this is only one exemplary use case.

The mounting system 10 includes a strap 14 including a first portion 16 and a second portion 18. The strap 14 is a long, thin, flexible member having a width and thickness much smaller than its length. The strap 14 may be made of a woven nylon, polyurethane, or other synthetic or natural fiber. One end of the second portion is secured to the attachment structure 12, such as by means of sewing on to a ring, buckle, or other attachment structure 12. Accordingly, the second first portion 16 is positioned between the attachment structure 12 and the second portion 18.

A first side (facing the viewer in FIG. 1) of the strap 14 in the first portion 16 may have a gripping material 20 secured thereto. The gripping material 20 may be a layer of rubber or other elastomer painted or otherwise applied to the first side of the strap 14. The gripping material 20 may be a layer of foam rubber secured to the first side of the strap 14 by means of adhesive, sewing, welding, or other fastening means.

The first side of the strap 14 in the second portion 18 may have a pressure-engaged releasable fastening element 22 secured thereto. For example, the fastening element 22 may be fabric with hooks or loops of a hook-and-loop fastening system, such as VELCRO®. For example, the fastening element 22 may be the hook portion of the hook-and-loop fastening system in some embodiments. Another example of such as fastening element 22 may include the 3M DUAL LOCK fastening system, which includes arrays of posts with widened heads that can interlock to secure to one another.

Referring specifically to FIGS. 2A and 3, a second side of the strap 14 (facing the viewer in FIG. 3) in the first portion may include a pressure-engaged releasable fastening element 24 that is configured to secure to the fastening element 22 upon being pressed together. For example, the fastening element 24 may be the loop portion of a hook-and-loop fastening system or another region of 3M DUAL lock material. As is apparent in FIGS. 2A and 3, the fastening element 24 extends along the first portion and may be coextensive with the gripping material 20 along the length of the strap 10, e.g. at least 90 percent of the fastening element 24 overlapping the gripping material 20 along the length of the strap 14.

Referring to FIG. 2B, in some embodiments, a pad 29 may secure to the second side of the second portion 18 opposite the pressure-engaged releasable fastening element 22. The pad 29 may enhance the comfort and gripping ability of the user when wrapping the strap 14 as described below. The pad may be made of rubber, foam rubber, silicone, neoprene, or other polymer that is compressible in order to function as a pad.

As is apparent in FIG. 3, the second side of the second portion 18 may lack any fastening element and may be exposed following installation. Accordingly, the second side may simply be an exposed surface of the strap 14 or may include some other wear resistant coating. As seen in FIGS. 1 and 2, there may be a gap between the gripping material 20 and fastening element 24 and the fastening element 22. As is also apparent, the lengths of the fastening elements 22, 24 is much longer than their widths and the width of the strap 10, e.g. between 5 and 15 times the width of the strap 10. The length of the strap 10 and the fastening elements 22, 24 may be application dependent: the longer the fastening elements 22, 24, the more wraps around a mounting structure may be performed.

Note also that the thickness of the gripping material 20 may be application dependent. The gripping material 20 may provide a biasing force that facilitates gripping against a mounting structure. As the diameter of the mounting structure increases, the thickness of the gripping material 20 may also be increased such that it can compress during installation and provide an adequate biasing force and grip.

In some embodiments, a tab 26 may secure to the first portion 16 of the strap 14 and project outwardly from the side of the strap 14. The tab 26 may have on its first side (i.e., facing the same way as the first side of the strap 14), a pressure-engaged releasable fastening element 28, which may be the same type as the fastening element 22. For example, where the fastening element 22 is hook material for a hook-and-loop fastening system, the fastening element 28 may also be hook material. As will be discussed below, the fastening element 28 may engage with the fastening element 24 during installation to hold the mounting system 10 in place temporarily until installation is completed. In some embodiments, the second side of the tab 26 opposite the first side may include a pressure-engaged releasable fastening element as well, such as the same type as the fastening element 24, which is loop material in the illustrated embodiment.

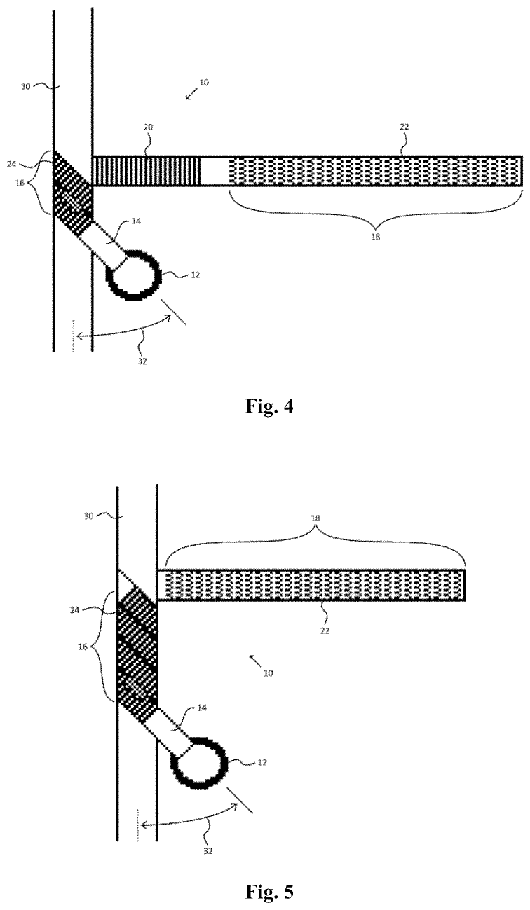

FIG. 4 illustrates initial wrapping of the mounting system 10 on a structure 30. the first portion 16 may be wrapped around the structure 30 first. As is apparent, the strap 14 is wrapped around the structure 30 at a wrapping angle 32 relative to the central axis of the structure 30 (the vertical direction in FIG. 4). The wrapping angle 32 may be non-perpendicular and non-parallel. For example, the wrapping angle 32 may be between 20 and 70 degrees, preferably between 30 and 60 degrees. The wrap angle 32 may be dependent on the width of the strap 14 relative to the structure 10: a wider strap will have a smaller angle and a narrower strap may have a larger angle 32. The initial wrapping is performed with the gripping material 20 (the first side of the first portion 16) facing and contacting the structure 30, leaving the second side of the first portion and the fastening element 24 exposed and facing outwardly from the structure 30. The initial wrapping may be performed such that tension is applied to the strap 14 effective to compress the gripping material 20, particularly where the gripping material 20 is a compressible foam rubber or other polymer.

As is apparent in FIG. 4, after the first or second loop of the strap 14 around the mounting structure 30, the fastening element 28 on the tab 26 may be engaged with the fastening element 24 in order to hold the mounting system 10 in place while continued wrapping of the first portion 16 around the structure 30 occurs.

Wrapping of the first portion 16 at the wrap angle 32 may continue until the configuration of FIG. 5 is achieved in which substantially all (e.g., at least 90 percent) of the second fastening element 24 is wrapped around the structure 30 and substantially all (e.g., at least 90 percent) of the second portion of the strap 14 is not wrapped around the structure 30. At this point, the second portion 18 of the strap 14 is wrapped back over the first portion 14. The overwrapping angle 34 of this step may be substantially equal to the wrap angle 32 relative to the central axis of the structure 30 but facing the opposite direction (e.g., 180 degrees minus the angle 32). The overwrapping results in the fastening element 22 being engaged with the fastening element 24, thereby securing the mounting system 10 to the structure 30. Tension may be applied during the overwrapping step in order to further compress the gripping material 20 and promote gripping of the structure 30. The gripping material then holds pressure on the structure 30 after being secured even when items move and the tension on the strap is slightly loosened, tightened, or pulled to one side or the other. It provides some resiliency to the securement of the strap.

Upon completion of overwrapping, the mounting system 10 may be secured to the structure 30 as shown in FIG. 7. The attachment structure 12 remains exposed and available to secure to another strap, another portion of a buckle, or other fastening structure. In some embodiments, the highest load capacity occurs when tension on the attachment structure 12 is applied at an angle 36 relative to the central axis of the structure 30 that is equal to the wrapping angle 32. However, some range of deviation, e.g. a tensioning angle 36 of up to 90 degrees or as low as the angle 32 minus 10 degrees.

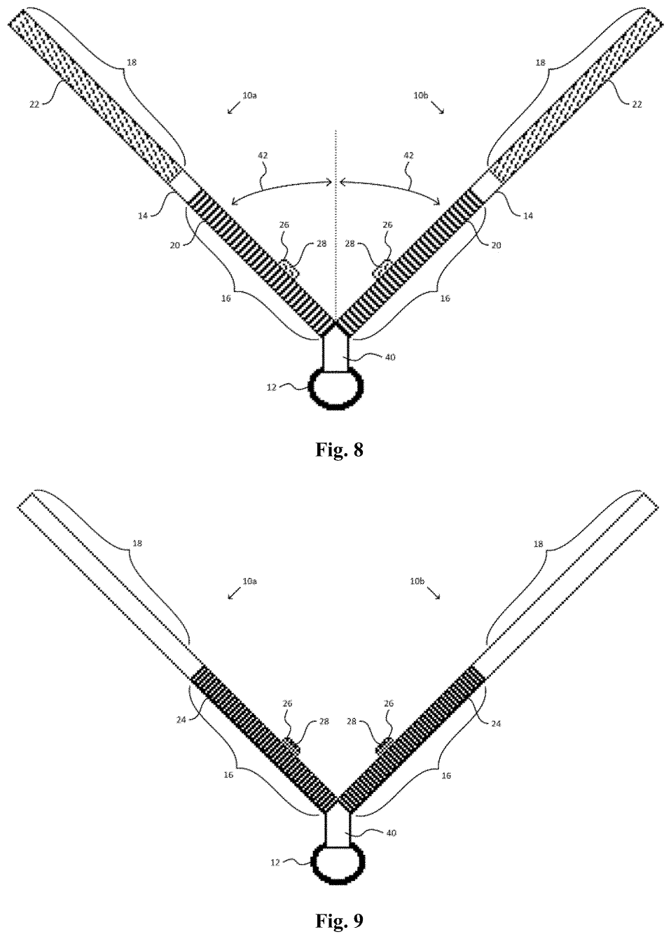

FIGS. 8 and 9 illustrate an alternative embodiment in which two mounting systems 10 (10a and 10b in FIG. 8) secure to a single attachment structure 12. As is apparent in FIGS. 8 and 9, the straps 14 of the mounting systems 10a, 10b may secure to a stub 40 having the attachment structure mounted thereto and the straps 14 may define angles 42 relative to a central axis of the stub 40. These angles maybe substantially (e.g., within 5 degrees) equal to the wrapping angles 32 for the straps 14. Stated differently, one half of the angle defined between the straps 14 of the mounting systems 10a, 10b may be substantially equal to the wrapping angle 32.

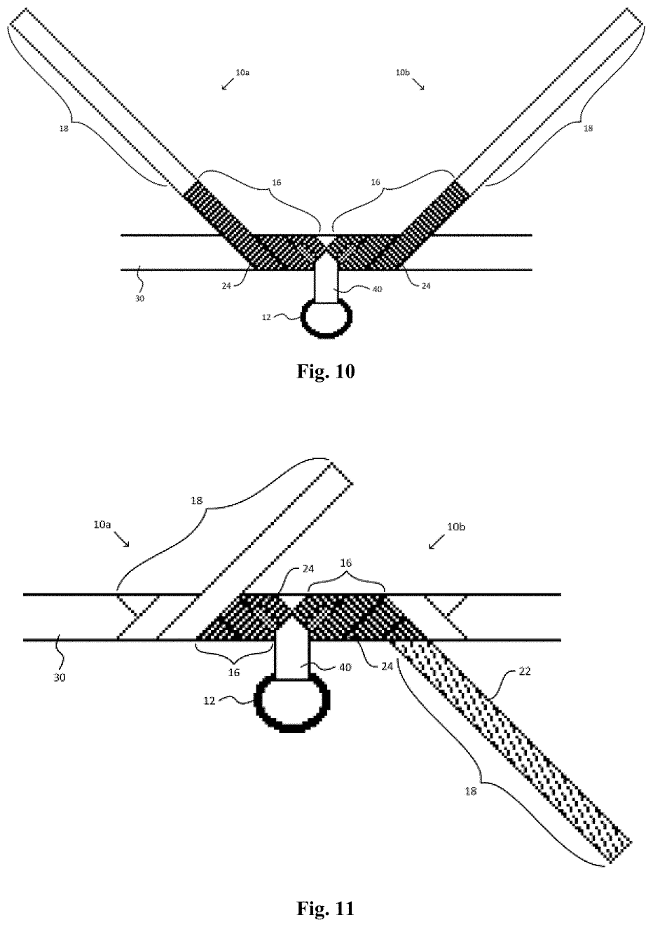

Referring to FIG. 10, in use the mounting systems 10a, 10b fasten to a structure 30 in the identical manner of a single mounting system 10 by first wrapping the first portions 16 around the structure 30 with the gripping material 20 facing the structure 30. As is apparent, the wrapping of the straps 14 of the mounting systems 10a, 10b proceeds at substantially the same wrapping angles 32 but facing in opposite directions. As shown in FIG. 10, the second portions 18 are then overwrapped onto the first portions 16 in the same manner as for a single mounting system 10 except that the overwrapping angle 34 of the mounting systems 10a, 10b are oriented in opposite directions.

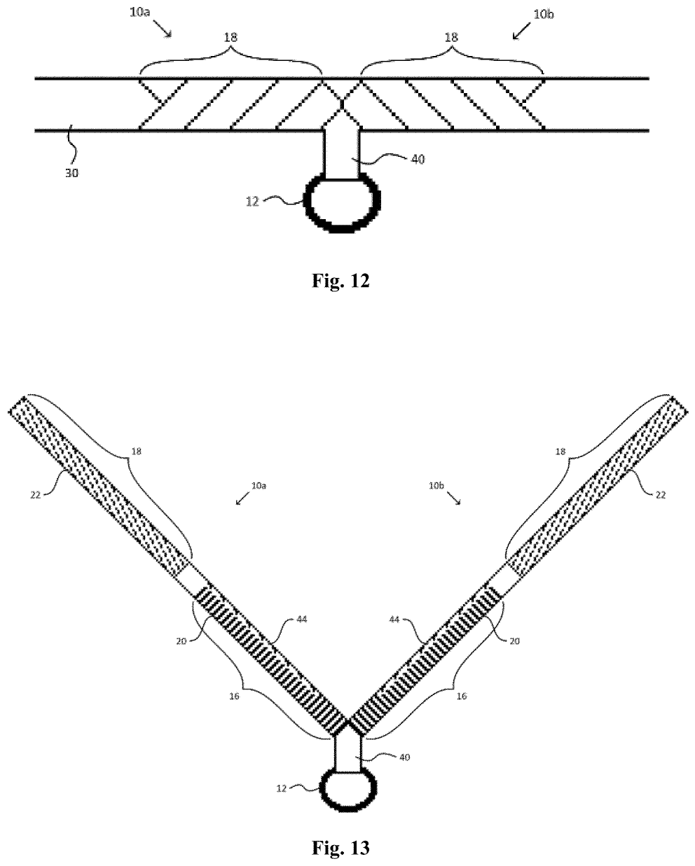

Following overwrapping, the mounting systems 10a, 10b may be as shown in FIG. 12. The illustrated configuration has the advantage that the tension angle 36 is now 90 degrees relative to the central axis of the structure 30, with some deviation (e.g. +/− 10 degrees) being permissible.

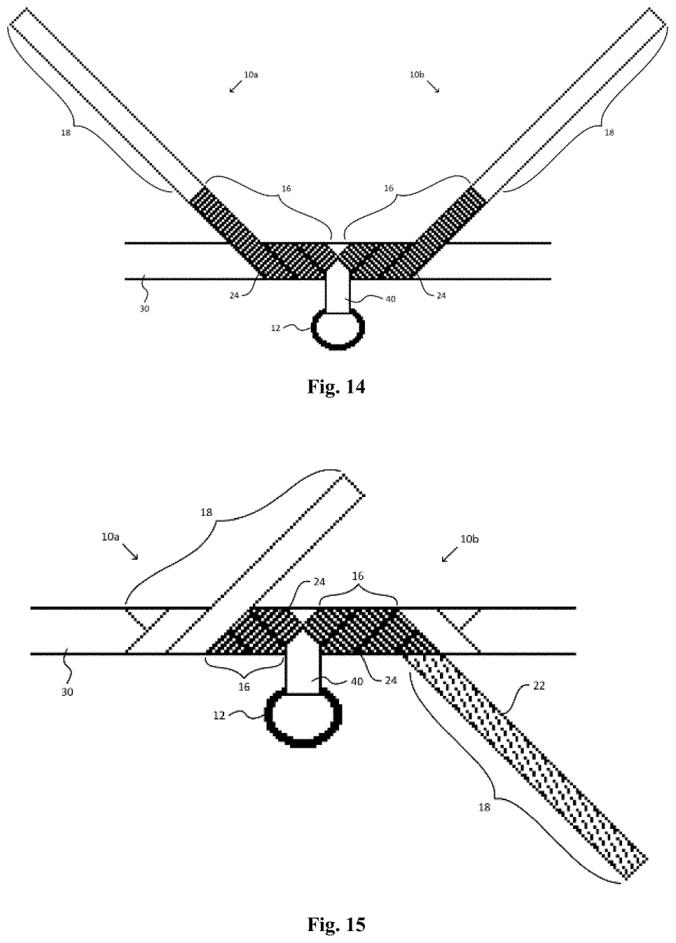

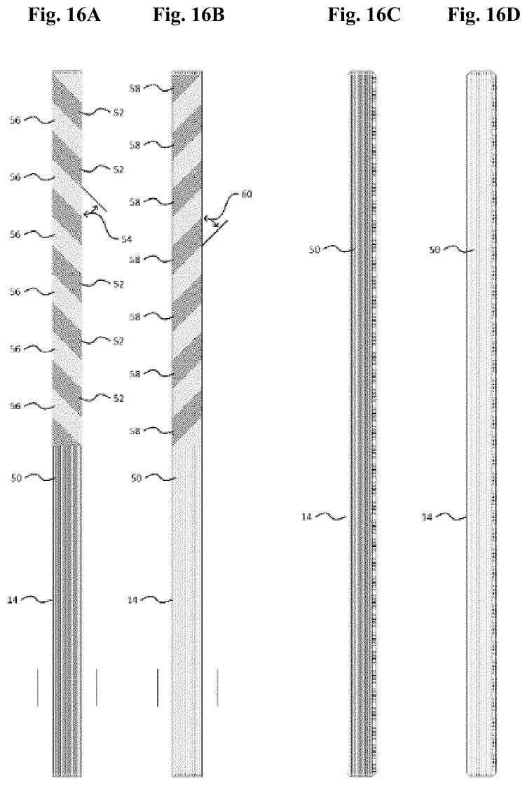

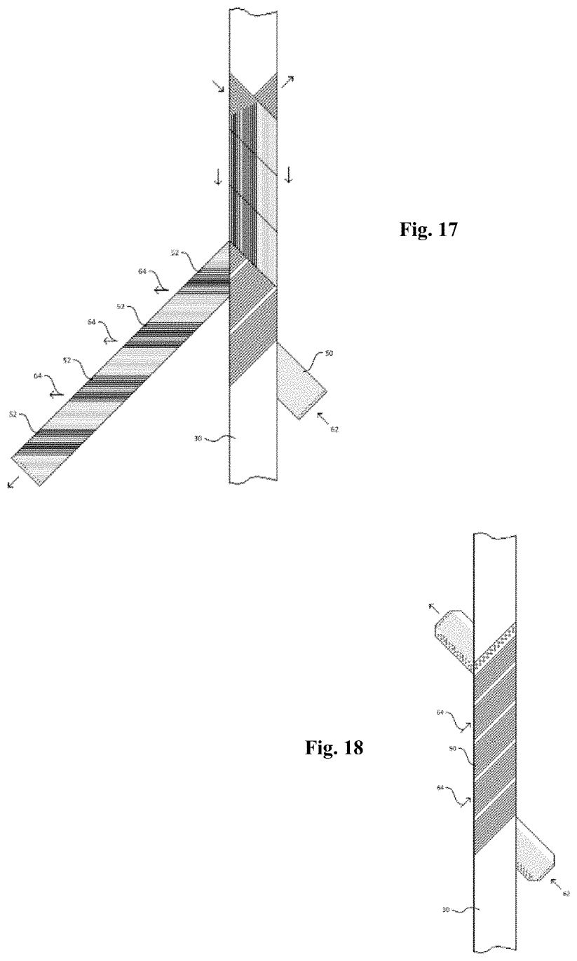

Referring to FIG. 13 illustrates an alternative implementation of the use of two mounting systems 10a, 10b. In this configuration, on the first side of the straps 14, the gripping material 20 is narrowed and a fastening element 44 secures to the first side along the gripping material. As is apparent, the gripping material 20 still occupies a major portion of the width of the strap, e.g. between 60 and 80 percent. The fastening element 44 may be of the same type as fastening element 22, i.e. hook material. In the illustrated embodiment, the fastening element 44 is positioned closer to the inner edges of the straps 14, i.e. the edges of the mounting systems 10a, 10b that face inwardly toward one another. In this manner, while wrapping the first portion 16, the strap 14 may overlap itself (see FIG. 14). such that the fastening element 44 engages the fastening element 24 thereby holding the mounting systems 10a, 10b in place. Note that the use of the fastening element 44 may be used in place of the tab 26 and fastening element 28 in the case of a single mounting system 10 in the same manner. Overwrapping for the embodiment of FIG. 13 may be performed in the same manner as for the embodiment of FIGS. 8-12 (see FIG. 15).

Referring to FIGS. 16A to 16D, in some embodiments, the strap 14 may incorporate conductors. These conductors may have the illustrated configuration and enable the mounting system 10 to function as a solenoid or electromagnet when coupled to a power source such as a battery, generator, or electrical power grid. The illustrated conductors may be incorporated into the strap 14 and the additional structures of the mounting system 10 may secured to a strap 14 configured as shown in FIGS. 16A to 16D.

FIG. 16A shows the first side of the strap 14 with the first portion 16 including straight conductors 50, i.e. extending parallel to the long dimension of the strap 14. In particular, the straight conductors may include a plurality of wires, printed or painted conductive material, or other form of conductive material. For example, there may be between 20 and 100 discrete conductors, i.e. conductors that are extend the length of the first portion without being in electrical contact with one another.

The second portion 18 includes groups of angled conductors 52 that may be formed in the same way as the conductors 50 and each group 52 may have the same number or different number of conductors as the conductors 50. The conductors of each group 52 may be oriented at an angle that is substantially equal (e.g., within 5 degrees of) the overwrapping angle 34. The groups of conductors 52 may be separated from one another by a gap 56. The width of this gap 56 measured perpendicular to the conductors of the groups of conductors 52 may be substantially equal to (e.g., within 5 percent of) the width of the strap 14 perpendicular to the long dimension (the horizontal direction in FIGS. 16A to 16D). In some embodiments, each of the conductors 50 is connected to one of the conductors in the group of conductors 52 closest to the conductors 50.

Referring to FIG. 16B, in some embodiments, on the second side of the straps, conductors 50 are omitted from the first portion. The second portion may include angled conductors having an angle 60 that is opposite the angle 54 when viewed from the back and therefore the oriented parallel to the conductors 52. The conductors 58 may be positioned opposite the gaps 56 between the conductors 56 along the length of the strap 14, i.e., the position of the conductors 58 along the long dimension of the strap may substantially (e.g., at least 90 percent, preferably 100 percent) overlap the position of the gaps 56 along the long dimension.

FIGS. 16C and 16D illustrate an alternative embodiment in which the conductors 50 extend along substantially all, e.g., at least 95 percent, of the length of the strap 14 on the first side and there are no conductors on the second side. In this embodiment, the conductors 50 are straight and extend along the long dimension of the strap in continuous lines.

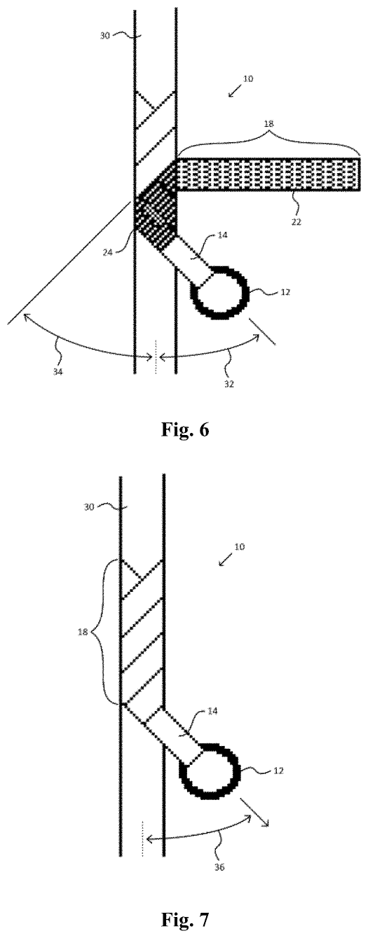

The strap 14 with conductors, as shown in FIGS. 16A and 16B, may be wrapped in the same manner as for the embodiment of FIGS. 1 through 7. As a result of the wrapping angle 32 and overwrapping angle 34 in relation to the angles 54 of the conductors 52, and possibly the angles 60 of the conductors 58, when installed in this manner the combination of the conductors 50 and 52, and possibly the conductors 58, provide a set of windings around the structure 30. In particular, current 62 input to the end of the first portion 16 will circulate around the structure 30. The conductors 52 when placed with their edges making electrical contact with one another during winding conduct current 64 that circulates around the structure 30 in the same direction, e.g. both currents 62, 64 will be clockwise or both will be counter clockwise.

The currents 62, 64 will induced a magnetic field that may be used for magnetizing the structure 30 in order to improve grip or may also function as a solenoid for inducing movement.

FIG. 18 illustrates wrapping of a strap 14 with conductors according to the embodiment of FIGS. 16C and 16D. As is apparent, the conductors 50 spiral around the mounting structure 30 when wrapped according to the embodiments disclosed herein and the input current 64 circulates around the mounting structure in order to induce a magnetic field.

Note further that the straps 14 incorporating conductors according to FIGS. 16A and 16B or FIGS. 16C and 16D may also be used in the embodiments including two mounting systems 10a, 10b.

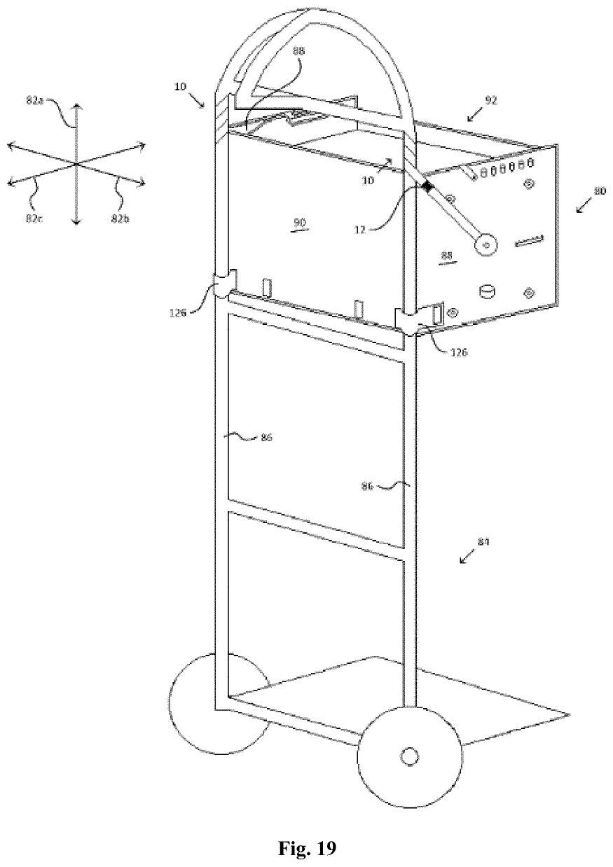

Referring to FIGS. 19 and 20, the mounting system 10 may be used to support the illustrated shelf assembly 80. The shelf assembly 80 may be understood with respect to a vertical direction 82a, a horizontal direction 82b, and a longitudinal direction 82c that are mutually perpendicular to one another. The shelf assembly 80 may be secured to a dolly 84, also known as a hand truck, or other structure. The shelf assembly 80 is particularly useful when securing to portable structures to enable the transport of tools and supplies to a work area. However, it should be understood that the shelf assembly 80 may also secure to stationary structures. It should also be understood that the mounting system 10 is only one example of a way to provide an attachment structure 12 for mounting of the shelf assembly 80 and any other type of fastening or mounting system may also be used.

The dolly 84 includes vertical supports 86, e.g. steel tubes, that are substantially (e.g., within 5 degrees) parallel to one another and substantially parallel to the vertical direction 82a during use of the shelf assembly 80. A mounting system 10 may secure to each of the supports 86 at substantially (e.g., within 1.5 inches) equal heights along the vertical direction 82a. As is apparent in FIG. 19, the attachment structure 12 is oriented downwardly at the overwrapping angle 34 and the attachment structure 12 is embodied as part of a buckle, such either part of a side release buckle. The dolly 84 may include wheels and a support platform for carrying items as known in the art and configured according to any approach known in the art.

The shelf assembly 80 may include a shelf housing including sidewalls 88 that are thin planar members having their largest surfaces oriented substantially parallel to the vertical and longitudinal directions 12a, 12c. The sidewalls 88 may have a thickness of between 3 and 20 mm in the horizontal direction 12b, a height in the vertical direction 12a of between 15 and 80 cm, a depth in the longitudinal direction 12c of between 20 and 60 cm, and a width (fixed or adjustable) between 60 and 240 cm. An 80 cm height may accommodate the height of a dolly or hand truck, whereas a 30 cm height may be preferable and multiple 30 cm shelves may be used.

Rear edges of the sidewalls 88 may be secured to a back wall 90 of the shelf housing. The back wall 90 may have a thickness and height within the same ranges as described above for the sidewalls 88. In particular, the back wall 90 may have a height in the vertical direction 12a substantially (within 1 cm) equal to that of the sidewalls 88.

The sidewalls 88 and back wall 90 may be covered in a wear resistant fabric and secured at their edges to one another by this fabric or a different fabric such that the sidewalls 88 may fold against the back wall 90 for shipping and storage and be folded out from the back wall 90 when deployed as shown in FIGS. 19 and 20. The wear resistant fabric may be a woven nylon, polyurethane, or other synthetic or natural fiber. In an alternative embodiment, folding of the sidewalls relative to the back wall 90 may be achieved using hinges securing the sidewalls to the back wall 90.

One or more shelves 92 may be supported between the sidewalls 88. The back wall 90 may provide a surface for preventing items from falling out of the shelves 92 when the dolly 84 is tipped or otherwise moved. The shelves 92 may be removable.

Each shelf 92 may include a bottom 94, front side 96, back side 98, left side 100a, and right side 100b. The bottom 94 may include a material of suitable strength and thickness in the vertical direction 12a to support items placed on the shelf 92 during typical use. For example, the bottom 94 may include a wooden plate, metal or plastic plate, or the like.

In some embodiments, the left and right sides 100a, 100b include rigid plates (wooden, metal, plastic) whereas the front and back sides 96, 98 lack a plate and are instead made of fabric. For example, the bottom 94, front side 96, back side 98, left side 100a, and right side 100b may include one or more layers of fabric, such as a tough, wear resistant nylon or polyurethane woven material. The bottom 94, left side 100a, and right side 100b may each include a plate encased between the two layers of the fabric and possibly adhered or welded to the two layers of fabric. As a result of this configuration, the left side 100a and right side 100b may be foldable toward the bottom layer 94 for compact storage during shipping or when not in use.

The width of the bottom 94, front side 96, and back side 98 along the horizontal direction 12b may be substantially equal to the width of the back wall 90, less some amount to permit easy insertion, e.g. the width of the back wall minus 5 to 15 mm.

The depth of the bottom 94 and left and right sides 100a, 100b along the longitudinal direction 82c may likewise be equal to the depth of the sidewalls 88 less some amount such that the shelves 92 do not protrude outwardly, e.g. 5 to 15 mm.

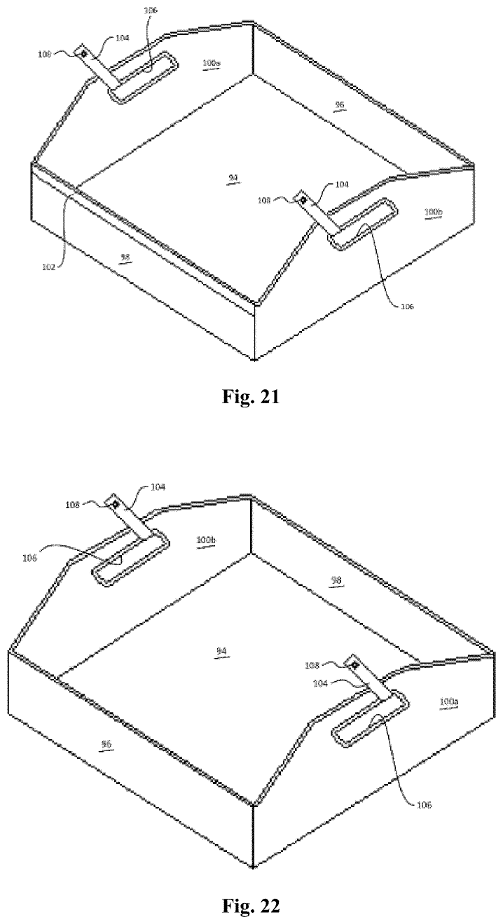

As is apparent in FIG. 21, the rear facing surface of the back side 98 may have a pressure-engaged releasable fastening element 102 (e.g., a magnetic coupling, hooks or loops of a VELCRO fastening system, 3M DUAL LOCK fastening element or the like). As is apparent, the fastening element 102 is positioned at the top edge of the back side 98, e.g. within 1 cm of the top of the back side 98 along vertical direction 12a, and extends across all or substantially all, e.g., at least 90 percent, of the width of the back wall 98. This may enable the back side 98 to be secured to the back wall 90 during use to prevent items from falling out of the shelf 92 during movement of the dolly or during placement and removal of items.

Straps 104 may secure to each of the sides 100a, 100b for securing the shelf 92 to the sidewalls 88. Securement of the straps 104 may further resist inward collapse of the sides 100a, 100b due to the front and back sides 96, 98 being flexible. In the illustrated embodiment, the sides 100a, 100b define openings 106 sized to receive the fingers of a user, i.e. to function as handles. The straps 104 may include a loop of material passing through these opening and securing back to the straps 104 to secure the straps 104 to the sides 100a, 100b. Each strap 104 may include a fastening element 108, such as a snap fastener, portion of a buckle, a pressure-engaged releasable fastening element for securing to a corresponding fastening element on one of the sidewalls 88.

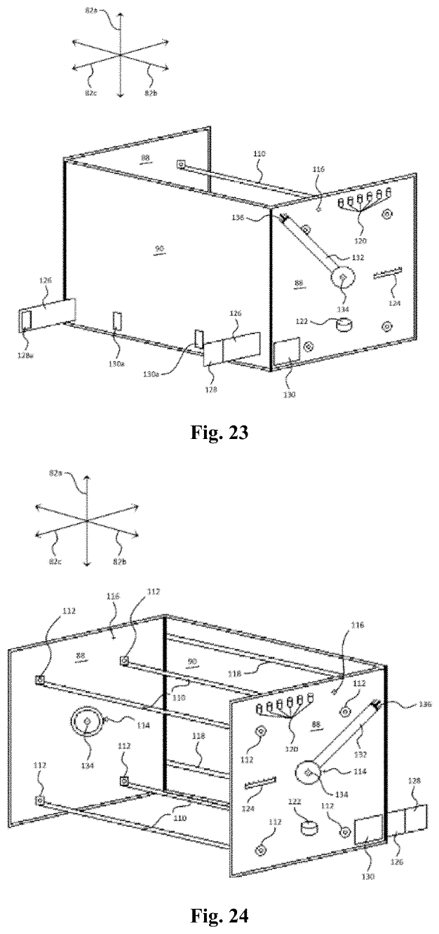

FIGS. 23 and 24 illustrate structures that may be secured to the sidewalls 88 and back wall 90 in order to facilitate securement of the shelves 92. There may be sets of cross straps 110 securing to both sidewalls 88 and having a length equal to or less than the width of the back wall 90 in the horizontal direction 12b. For example, for each shelf 92 used, there may be a set of two or more straps 110 at substantially (e.g., within 1 to 2 cm) the same position along the vertical direction 12a. The two or more straps 110 may be offset from one another along the longitudinal direction 12c by a distance, e.g. between 25 and 50 percent of the depth of the sidewalls 88 in the longitudinal direction 12c, in order to provide a stable support for the shelf 92. The straps 110 may be secured to sidewalls 88 by fasteners 112. Washers of meatal or plastic on either side of the sidewalls 88 may be used to prevent the fasteners 112 from being pulled free from the sidewalls 88. Alternatively, other types of reinforcement may be used, such as gromets. The straps 110 may be flexible and therefore not interfering with folding of the sidewalls 88 with respect to the backwall. For example, the straps 110 may be made of woven nylon, polyurethane, or any other synthetic or natural fiber.

In the illustrated embodiment, fastening elements 114 are secured to inward facing surfaces of the sidewalls 88 above the position of the straps 110 in the vertical direction 12a such that when the shelf 92 is placed on the straps 110 and the fastening element 102 of the straps 104 secured to the fastening elements 114, the sides 100a, 100b will be substantially (within 10 degrees of) perpendicular to the bottom 94 of the bottom shelf 92, which will also result in tensioning and lifting of the front and back sides 96, 98.

For the top shelf 92, fastening elements 116 may be provided on outward facing surfaces of the sidewalls 88. Accordingly, the straps 104 will be lifted over the top edge of the sidewalls 88 and the fastening elements 102 engaged with the fastening elements 116 such that the sides 100a, 100b will be substantially (within 10 degrees of) perpendicular to the bottom 94 of the top shelf 92, which will also result in tensioning and lifting of the front and back sides 96, 98.

For each shelf position, e.g., each set of straps 110, a pressure-engaged releasable fastening element 118 may be secured to an inward facing surface of the back wall 90 and positioned to engage the fastening element 102 on the back side 98 of the shelf 92 rested on that set of straps. In use, a user will typically press the back side 98 against the fastening element 118 in order to engage it and prevent items from falling between the back side 98 and the back wall 90.

Other structures may secure to outward facing surfaces of the sidewalls 88 for holding tools or other equipment. For example, these may include small sleeves 120 for receiving screw drivers or other slender items and one or more large sleeves 122 for receiving a handle of a hammer or other tool. In some embodiments, a metal, plastic, or fabric strip 124 provides a location for clipping on an item such as tape measure.

A bottom of the back wall 90 and sidewalls 88 may be secured to the vertical supports 86 of the dolly 84. In the illustrated embodiment, straps 126 secure to the back wall 90 near (e.g., within 1 to 10 cm of) the corners with the sidewalls 88. The straps 126 include pressure-engaged releasable fastening elements 128, such a hook or loop portions for VELCRO or 3M DUAL LOCK fastening elements. Other pressure-engaged releasable fastening elements 130 may be secured to the sidewalls 88, such as within 1 to 10 cm of the corner between the sidewall 88 and the back wall 90. Accordingly, as best seen in FIG. 19, the straps 126 may be wrapped around the vertical supports 86 and the fastening elements 128 may be engaged with the fastening elements 130. As is apparent in the illustrated embodiment, the width of the back wall 90 may be equal to or less than the width of the vertical supports 86, i.e. the separation between outward facing surfaces of the supports 86. In other embodiments, the straps 126 may be secured to the sidewalls 88 and the fastening elements 130 may be secured to the back wall 90. In the illustrated embodiments, the straps 126 and fastening elements 130 secure near the bottom of the back wall 90 and sidewalls 88, such as within 1 to 5 cm from the bottom edges of the back wall 90 and sidewalls 88. In other embodiments, the straps 126 secure to the sidewalls 88 and the fastening elements 130 secure to the back wall 90.

Note that in some embodiments, additional fastening elements 130a may secure to the back wall 90. The fastening elements 130a may provide an alternative fastening location for the straps 126, such as in order to accommodate a narrower dolly or to hold straps 126 in place during installation until the user is prepared to connect them to the fastening elements 130. In such embodiments, the straps 126 may additionally include fastening elements 128a fastened thereto on opposite sides of the straps 126 from the fastening elements 128 and that may be engaged with the fastening elements 130a.

Straps 132 may secure to outer surfaces of the sidewalls 88 by means of a fastener 134 and be secured have an attachment structure 134 secured thereto, the attachment structure 136, such as a ring, part of a buckle, or some other type of attachment structure. For example, the attachment structure 136 may be configured to engage with the attachment structure 12 of the mounting systems 10 and may therefore be embodied as part of a side release clip or other type of buckle corresponding to the attachment structure 12, i.e. configured to engage the attachment structure 12. For example, attachment structure 136 may be a sleeve and the attachment structure 12 may include a three-pin connector that inserts within the sleeve to form a side-release buckle as known in the art.

The fastener 134 may permit pivoting of the strap 132 in order to connect to the attachment structure 12. The attachment point of the fastener 134 and the length of the strap 132 may be such that when secured to the attachment structure 12 with the back wall 90 secured to the vertical supports 86, the direction of application of tension on the strap 132 is substantially (e.g., within 10 degrees) equal to the wrap angle 32 of the mounting system 10 relative to the central axis of the vertical supports 86.

The fastener 134 may be positioned substantially at the center of the sidewall 88 along both of the vertical direction 82a and the longitudinal direction 82c. For example, the position of the fastener 134 in the vertical direction 82a may be within 10 percent of the height of the sidewall 88 from the center of the sidewall 88 in the vertical direction 82a. Likewise, the position of the fastener 134 in the longitudinal direction 82c may be within 10 percent of the depth of the sidewall 88 from the center of the sidewall 88 in the longitudinal direction 82c.

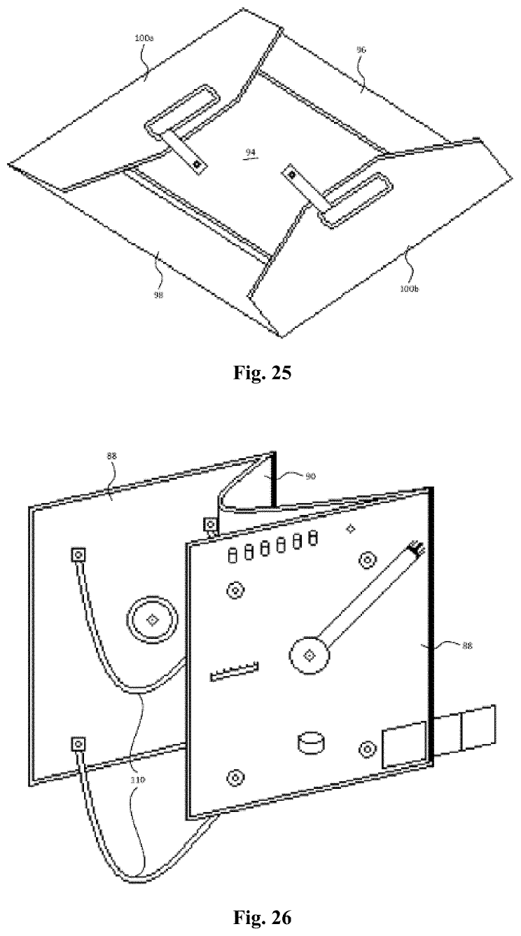

FIG. 25 illustrates how a shelf may be configured upon folding. As is apparent, the sides 100a, 100b are folded inward and, as a result, the front and back sides 96, 98 are folded down onto the bottom. As is apparent, deformation of the front and back sides at the corners will result from this folding.

FIG. 26 illustrates folding of the shelf housing. In the illustrated embodiment, the sidewalls 88 are brought toward one another and the back wall 90 is folded in between them. The straps 110 become slack and can be stowed between the sidewalls 88 in the folded configuration.

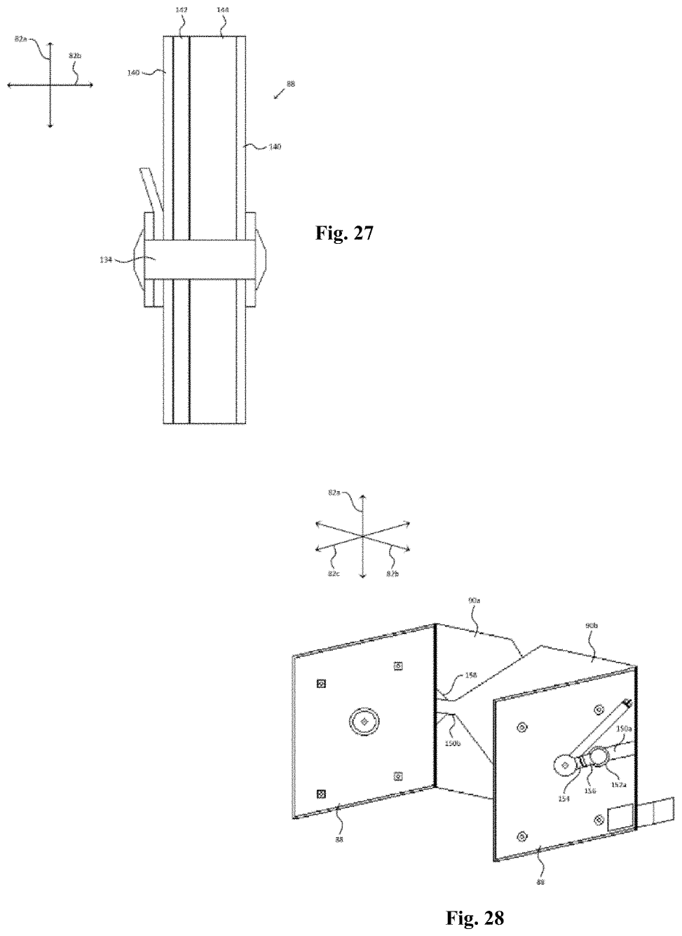

FIG. 27 illustrates layers that may make up the sidewall 88 and further illustrate how each strap 132 is secured to one of the sidewalls 88. The sidewall 88 may include inner and outer fabric layers 140. As noted above, the fabric may be a wear resistant fabric made of nylon, polyurethane, or other type of natural or synthetic fiber. Between the fabric layers 140 may be a support layer 142 and a crushable layer 144. The support layer 142 is a material of sufficient strength and stiffness to avoid bending or breaking during use. The support layer 142 may be layer of wood, rigid plastic, metal, or other suitable material. The crushable layer 144 may be made of corrugated paper, metal or plastic such that when the fastener 134 is tightened, the layer 144 deflects and provides a restoring force holding the fastener 134 in place. In some embodiments, washers 146 may be interposed between the fastener 134 and the outer fabric layers 140 in order to distribute loading over the crushable layer 144 and ensure that deformation is elastic and will result in a restoring force.

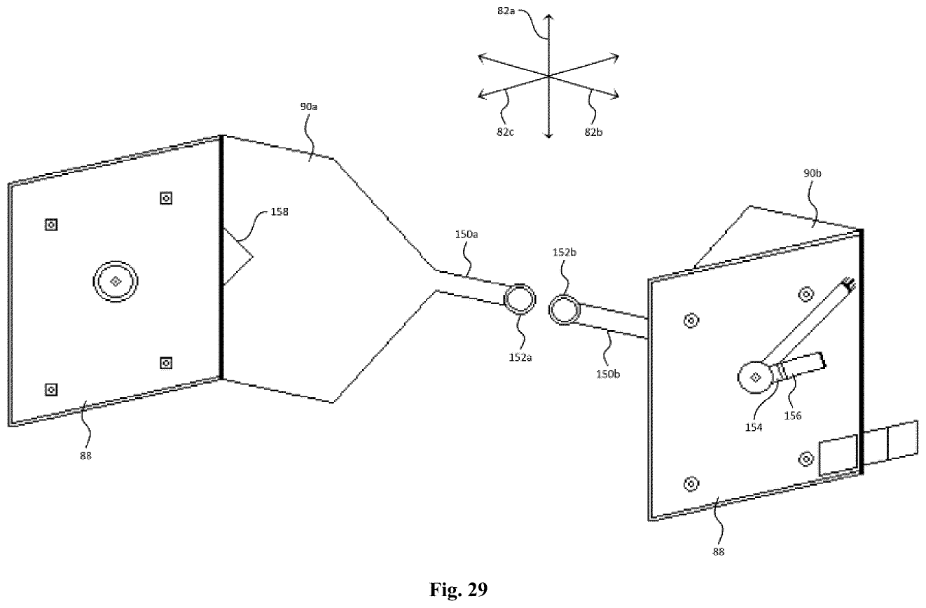

FIGS. 28 and 29 illustrate an alternative embodiment of a shelf housing that is expandable along the horizontal direction 82b. In the illustrated embodiment, the back wall 90 is divided into a left portion 90a secured to the left sidewall 88 and a right portion 90b secured to the right sidewall 88. A strap 150a is secured to the left portion 90a and includes a fastener 152a. A strap 159b is secured to the right portion 90b and includes a fastener 152b. As is apparent in FIG. 26, the straps secure to the free edge of the portions 90a, 90b and the free edge may taper with distance from the edge secured to the sidewall 88. In the illustrated embodiment, the fasteners 152a, 152b are embodied as rings. The fasteners 152a, 152b may also be embodied as buckles, such as portions of a side-release buckle.

The fasteners 152a, 152b may secure to corresponding fastening structures on outward facing surfaces of the sidewall 88. In the illustrated embodiment the fastening structure includes a strap 154 secured to each sidewall 88, such as by the fastener 134. The strap 154 may have one or more fastening element 156 secured thereto, such as a pressure-engaged fastening element according to any of the foregoing embodiments. In particular, the fastening element 156 may include 3M DUAL LOCK material, or both a hook fastening element and a loop fastening element according to the VELCRO fastening system.

As shown in FIG. 28, in use, the fastener 152a is engaged with the fastening element 156 on the right sidewall 88. This may include folding the strap 154 and fastening element 156 around the fastener 152a (e.g. ring) and engaging the fastening element 156 with itself (e.g., engaging a hook portion with a loop portion for VELCRO or engaging a first portion of 3M DUAL LOCK material with a second portion of the same material). The fastener 152b is engaged with the strap 154 and fastening element 156 on the left sidewall in the same manner.

One or both of the portions 90a, 90b may include a pass through opening 158 in order to permit the strap 150a, 150b and fastener 152a, 152b of the other portion 90b, 90a to pass therethrough. In the illustrated embodiment, the pass through opening is defined by portion 90a to permit the strap 150b and fastener 152b to pass therethrough. In the illustrated embodiment, the opening 158 is defined at the junction between the portion 90a and the left sidewall 88. However, other positions along the portion 90a may also be used for the opening 158.

An opening 158 is either not present in the portion 90b or is defined in a mirrored configuration. In particular, the strap 150a and fastener 152a may be passed around the back facing surface of the portion 90b such that an opening 158 is not needed.

The embodiment of FIGS. 28 and 29 is particularly useful to accommodate dollies having different widths. For example, a user may secure the straps 126 around the supports 86 of the dolly and secure the fasteners 136 to the fasteners 12 of mounting systems 10 on the supports 86, or some other mounting system. The straps 150a, 150b and fasteners 152a, 152b may then be positioned as shown in FIG. 28. The fastening elements 156 may then be engaged. The variability in position of the fastening elements 156 may provide for the straps 150a, 150b to be tensioned at various lengths to accommodate different separations between the supports 86. In some embodiments, the fastener 152a, 152b may be or include a buckle such that the extent of the straps 150a, 150b extending to the fasteners 152a, 152b from the portions 90a, 90b may be adjusted.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An apparatus comprising:
a strap having a first end and a second end and a first portion including the first end and a second portion including the second end;
a gripping material secured to a first side of the first portion;
a first pressure-engaged releasable fastening element secured to a second side of the first portion;
a second pressure-engaged releasable fastening element secured to a first side of the second portion; and
an attachment structure secured to the first end and configured to fasten to an item secured thereto.

2. The apparatus of claim 1, wherein the first pressure-engaged releasable fastening element is loop material for a hook-and-loop fastening system and the second pressure-engaged releasable fastening element is hook material for the hook-and-loop fastening system.

3. The apparatus of claim 1, wherein the first pressure-engaged releasable fastening element and the second pressure-engaged releasable fastening element are 3M DUAL LOCK material.

4. The apparatus of claim 1, further comprising a tab secured to the first portion and protruding outwardly therefrom a first side of the tab facing a same direction as a first side of the strap, the first side of the tab having a third pressure-engaged releasable fastening element secured thereto.

5. The apparatus of claim 4, wherein the third pressure-engaged releasable fastening element is of a same type as the second pressure-engaged releasable fastening element.

6. The apparatus of claim 5, wherein a second side of the tab is opposite the first side and has a fourth pressure-engaged releasable fastening element, the fourth pressure-engaged releasable fastening element being of a different type from the third pressure-engaged releasable fastening element and a same type as the second pressure-engaged releasable fastening element.

7. The apparatus of claim 1, wherein the gripping material is a coating of a gripping polymer.

8. The apparatus of claim 1, wherein the gripping material is a polymer foam adhered to the strap.

9. The apparatus of claim 1, wherein the attachment structure is a loop.

10. The apparatus of claim 9, wherein the attachment structure is a ring secured to the strap.

11. The apparatus of claim 1, wherein the attachment structure is a portion of a buckle.

12. The apparatus of claim 1, wherein the attachment structure is a portion of a side-release buckle.

13. A method comprising:
providing a mounting system including:
a strap having a first end and a second end and a first portion including the first end and a second portion including the second end;
a gripping material secured to a first side of the first portion;
a first pressure-engaged releasable fastening element secured to a second side of the first portion; and
a second pressure-engaged releasable fastening element secured to a first side of the second portion;
providing an attachment structure secured to the first end and configured to fasten to an item secured thereto;
wrapping the first portion around a mounting structure having the gripping material facing and contacting the mounting structure; and
wrapping the second portion around the first portion such that the second pressure-engaged releasable fastening element engages the first pressure-engaged releasable fastening element.

14. The method of claim 13, wherein wrapping the first portion around the mounting structure comprises wrapping the first portion at a wrapping angle relative to the mounting structure.

15. The method of claim 14, wherein wrapping the second portion around the first portion comprises wrapping the second portion at an overwrapping angle oriented in an opposite direction from the wrapping angle.

16. The method of claim 14, wherein the wrapping angle is between 20 and 70 degrees.

17. The method of claim 14, wherein the wrapping angle is between 30 and 60 degrees.

18. The method of claim 13, wherein the mounting system is a first mounting system, the method further comprising providing a second mounting system secured to the attachment structure, the method further comprising:
securing the second mounting system to the mounting structure.

19. The method of claim 13, wherein the mounting system further comprises a tab secured to the first portion and projecting outwardly therefrom, a third pressure-engaged fastening element being secured to a first side of the first portion facing a same direction as the first side of the first portion, the method further comprising:
wrapping part of the first portion around the mounting structure and engaging the first pressure-engaged fastening element with the third pressure-engaged fastening element effective to hold the mounting system in place on the mounting structure during wrapping of a remainder of the first portion around the mounting structure.

20. The method of claim 13, wherein the first pressure-engaged fastening element and the second pressure-engaged fastening element are materials according to at least one of a hook-and-loop fastening system and 3M DUAL LOCK fastening system.
